(19) United States
(12) Patent Application Publication
(10) Pub. No.: US 2023/0036289 A1
(43) Pub. Date: Feb. 2, 2023

(54) SOFTWARE MODEL TESTING FOR MACHINE LEARNING MODELS

(71) Applicant: Bank of America Corporation, Charlotte, NC (US)

(72) Inventors: Nishant Shah, Indian Land, SC (US); Karen Trevino, Plano, TX (US); Smruti Soumya Mishra, Concord, NC (US); Maruthi Shanmugam, McKinney, TX (US)

(21) Appl. No.: 17/386,812

(22) Filed: Jul. 28, 2021

(51) Int. Cl. G06K 9/62; G06N 20/20

(52) U.S. Cl. CPC G06K 9/6262; G06K 9/6202; G06N 20/20

(57) ABSTRACT

A device configured to receive a user input that identifies a machine learning model type and hyperparameters for a set of machine learning models and to generate the set of machine learning models based on the hyperparameters. The device is further configured to convert training data into a first set of hexadecimal values and to train the set of machine learning models using the first set of hexadecimal values. The device is further configured to convert test data into a second set of hexadecimal values and to obtain a classification value in response to inputting the second set of hexadecimal values into the set of machine learning models. The device is further configured to determine performance metrics for each machine learning model, to generate a model comparison report that comprises the performance metrics for each machine learning model, and to output the model comparison report.

### TECHNICAL FIELD

The present disclosure relates generally to software development, and more specifically to software model testing for machine learning models.

### BACKGROUND

Evaluating the performance of different types of machine learning models poses several technical challenges. For example, different types of machine learning models may have different kinds of inputs and/or outputs which makes directly comparing their performance against each other challenging. For instance, some machine learning models may be configured to receive images as an input whereas other machine learning models may be configured to receive text as an input. Using a conventional software test environment, there is no way to compare the performance between these types of machine learning models since they each use different types of inputs. This limitation makes it difficult for conventional software testing systems to compare the performance of different machine learning models against one another.

### SUMMARY

The disclosed system provides several practical applications and technical advantages that overcome the previously discussed technical problems. For example, the disclosed system provides a practical application by providing a process that allows different types of machine learning models to be generated and compared to each other. This process involves converting training data and test data from their original format to a hexadecimal representation (i.e. a base-16 numeric value). This conversion allows the training data and the test data to be used as a universal input to a machine learning model regardless of the type of machine learning model. The machine learning models are then trained using the training data which configures the machine learning models to use hexadecimal values as an input. By using hexadecimal values as an input, the machine learning models become agnostic to the type of data that is input into the machine learning models before the hexadecimal conversion process. In other words, this process allows machine learning models to operate using hexadecimal values as inputs regardless of the original format of the data before being converted into hexadecimal values. This process provides a technical advantage over existing techniques which are unable to make direct comparisons between different types of machine learning models or machine learning models that use different types of inputs. This process improves the field of software development and testing by transforming a software testing system into a state that allows the software testing system to create a test environment where multiple types of machine learning models can be compared to directly each other This process also improves the functioning of a software testing device by improving the device's ability to efficiently configure and test multiple types of machine learning models regardless of the types of input formats that they are natively configured to use. This improves the operation of the device by increasing the functionality of the device when generating and evaluating multiple machine learning models. This process also allows the device to identify the machine learning model that performs best on the device based on the specific software and hardware configuration of the device. This provides a technical advantage by enabling the device to evaluate multiple types of machine learning models to identify which type of machine learning model and settings provide the best performance when operating on the device.

In one embodiment, the system comprises a device that is configured to receive a user input that identifies a machine learning model type and hyperparameters for a set of machine learning models. The device is further configured to generate the set of machine learning models based on the hyperparameters. The device is further configured to convert training data into a first set of hexadecimal values and to train the set of machine learning models using the first set of hexadecimal values. The device is further configured to convert test data into a second set of hexadecimal values and to obtain a classification value in response to inputting the second set of hexadecimal values into the set of machine learning models. The device is further configured to determine performance metrics for each machine learning model, to generate a model comparison report that comprises the performance metrics for each machine learning model, and to output the model comparison report.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a software testing system that is configured to test machine learning models;

FIG. 2 is a flowchart of an embodiment of a machine learning model testing process for the software testing system; and

FIG. 3 is an embodiment of a device configured to test machine learning models.

### DETAILED DESCRIPTION

### System Overview

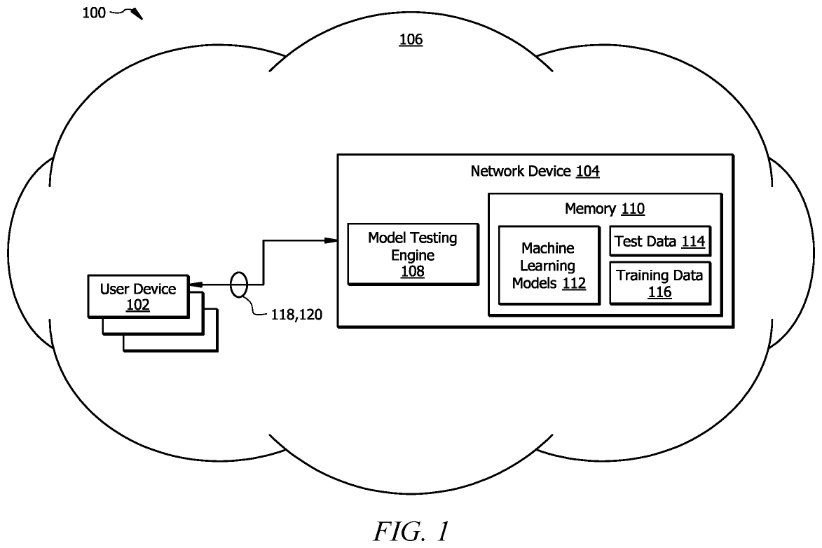

FIG. 1 is a schematic diagram of an embodiment of a software testing system 100 that is configured to test machine learning models 112. The software testing system 100 is generally configured to generate, test, and compare a set of machine learning models 112. The software testing system 100 is configured to generate multiple instances of machine learning models 112 that each have different hyperparameters and settings. After generating the machine learning models 112, the software testing system 100 uses a common set of training data 116 and test data 114 to evaluate the performance of the machine learning models 112. The training data 116 and the test data 114 are both converted from their original format to a hexadecimal representation (i.e. a base-16 numeric value). This conversion allows the training data and the test data to be used as a universal input to a machine learning model 112 regardless of the type of machine learning model 112. The machine learning models 112 are trained using the training data 116 which configures the machine learning models 112 to use hexadecimal values as an input. By using hexadecimal values as an input, the machine learning models 112 become agnostic to the type of data that is input into the machine learning models 112 before the hexadecimal conversion process. This process allows the software testing system 100 to create a test environment where multiple types of machine learning models 112 can be compared to directly each other. Conventional software testing systems are unable to perform a similar type of comparison because different types of machine learning models 112 may employ different kinds of inputs and/or outputs which makes directly comparing their performance challenging.

In one embodiment, the software testing system 100 comprises one or more user devices 102 and a network device 104 that are in signal communication with each other over a network 106. The network 106 may be any suitable type of wireless and/or wired network including, but not limited to, all or a portion of the Internet, an Intranet, a private network, a public network, a peer-to-peer network, the public switched telephone network, a cellular network, a local area network (LAN), a metropolitan area network (MAN), a personal area network (PAN), a wide area network (WAN), and a satellite network. The network 106 may be configured to support any suitable type of communication protocol as would be appreciated by one of ordinary skill in the art.

### User Devices

Examples of user devices 102 include, but are not limited to, a smartphone, a tablet, a laptop, a computer, a smart device, an Internet-of-Things (IoT) device, or any other suitable type of device. A user device 102 is configured to provide a user input 118 with instructions for generating and testing machine learning models 112. In one embodiment, the user input 118 identifies a machine learning model type and hyperparameters for a set of machine learning models 112. The machine learning model type identifies a type of algorithm or machine learning model to be generated and tested. Examples of machine learning model types include, but are not limited to, a multi-layer perceptron, a recurrent neural network (RNN), an RNN long short-term memory (LSTM), a convolutional neural network (CNN), deep learning algorithms, probabilistic models, a linear regression, a non-linear regression, or any other suitable type of algorithm or model. The hyperparameters comprise settings for generating and configuring a set of machine learning models 112. For example, the hyperparameters may identify a quantity value that identifies a number of machine learning models 112 to generate and setting for configuring one or more machine learning models 112. For instance, the hyperparameters may comprise a quantity value that indicates for the network device 104 to create two machine learning models 112. In this example, the hyperparameters may further comprise two different settings that are specific to each of the machine learning models 112. Other examples of parameters or settings include, but are not limited to, a sensitivity level, a tolerance level, an epoch value, a number of layers (e.g. hidden layers), a number of inputs, a number of outputs, an output type, an output format, or any other suitable type or combination of settings.

The network device 104 is further configured to receive a model comparison report 120 and to present the model comparison report 120 to a user using a graphical user interface (e.g. a display or touch screen). The model comparison report 120 comprises information about the testing of a set of machine learning models 112. The model comparison report 120 comprises performance metrics that identify the performance of one or more machine learning models 112 and/or the performance of the network device 104 while evaluating the machine learning models 112.

### Network Device

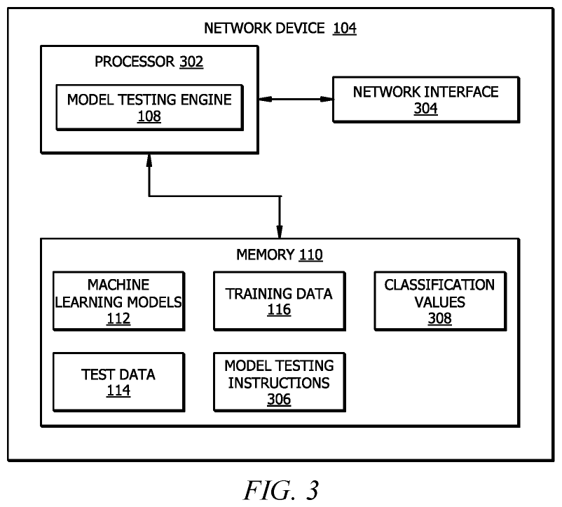

Examples of the network device 104 include, but are not limited to, a server, a computer, a laptop, or any other suitable type of network device. In one embodiment, the network device 104 comprises a model testing engine 108 and a memory 110. Additional details about the hardware configuration of the network device 104 are described in FIG. 3. The memory 110 is configured to store machine learning models 112, test data 114, training data 116, and/or any other suitable type of data.

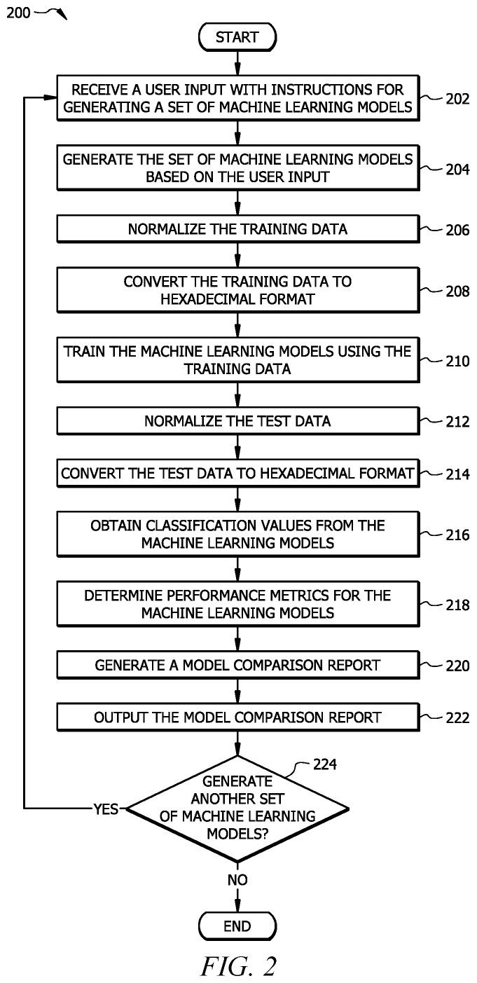

In one embodiment, the model testing engine 108 is generally configured to generate a set of machine learning models 112 based on instructions provided in a user input 118. The model testing engine 108 is further configured to train the machine learning models 112 and to evaluate their performance. This process involves converting test data 114 and training data 116 into hexadecimal values that can be used as an input into any type of machine learning model 112. This process allows the model testing engine 108 to compare different types of machine learning models 112 using a common set of training data 116 and test data 114. An example of the model testing engine 108 in operation is described in more detail below in FIG. 2.

The training data 116 may comprise text, numerical values, documents, images, or any other suitable type data that can be input into a machine learning model 112. The test data 114 is the same data type as the training data 116. In some embodiments, the test data 114 is a subset or a portion of the training data 116. For example, twenty percent of the training data 116 may be used as test data 114.

Examples of machine learning models 112 include, but are not limited to, a multi-layer perceptron, an RNN, an RNN LSTM, a CNN, deep learning algorithms, probabilistic models, a linear regression, a non-linear regression, or any other suitable type of algorithm or model. Each machine learning model 112 is generally configured to receive test data 114 as an input and to output a classification value 308 based on the provided test data 114. The classification value 308 identifies an input to a machine learning model 112 based on the features or characteristics of the input.

### Machine Learning Model Testing Process

FIG. 2 is a flowchart of an embodiment of a machine learning model testing process 200 for the software testing system 100. The software testing system 100 may employ process 200 to generate, test, and compare a set of machine learning models 112. Process 200 allows the software testing system 100 generate multiple instances of machine learning models 112 that each have different hyperparameters and settings. Process 200 then trains, tests, and compares the performance of the machine learning models 112 using a common set of training data 116 and test data 114. This process allows the software testing system 100 to create a test environment where multiple types of machine learning models 112 can be compared to directly each other.

At step 202, the network device 104 receives a user input 118 for generating a set of machine learning models 112. In one embodiment, the user input 118 identifies a machine learning model type and hyperparameters that comprise a quantity value that identifies a number of machine learning models 112 to generate and setting for one or more machine learning models 112. For example, the user input 118 may specify the type of machine learning model or algorithm that is to be generated, the number machine learning models 112 to generate, and settings that are to be used for each of the machine learning models 112 that is generated. In other embodiments, the user input 118 may comprise any other suitable type of instructions for generating, configuring, or testing machine learning models 112 and/or instructions for outputting the results from testing machine learning models 112.

In one example, the network device 104 may receive the user input 118 from a user device 102. In this example, the user device 102 may send the user input 118 as a message to the network device 104. The user device 102 may use any suitable type of messaging format or protocol to send the user input 118 to the network device 104. As another example, the network device 104 may receive the user input 118 from a user that is using the network device 104 as a computing device. In this example, the user may provide the user input 118 via an application or graphical user interface.

At step 204, the network device 104 generates the machine learning models 122 based on the user input 118. The network device 104 uses the user input 118 to identify the number of machine learning models 112 to generate and the types of machine learning models 112 to generate. In some embodiments, the user input 118 may not identify a particular machine learning model type. In this case, the network device 104 may select a machine learning model type based on the type of source data that will be used with the machine learning model 112. For example, the network device 104 may select a machine learning model type based on a data type and/or an amount of data that will be processed by the machine learning model 112. After generating the machine learning models 112, the network device 104 then uses the hyperparameter settings to configure each of the machine learning models 112. The hyperparameter settings may be specific to each machine learning model 112. The hyperparameter settings may include a unique combination of parameters and settings for each machine learning model 112. This process allows the network device 104 to create multiple unique machine learning models 112 that can be evaluated and compared to each other.

At step 206, the network device 104 normalizes the training data 116. Here, the network device 104 may pre-process the training data 116 by converting the training data 116 into a suitable format that can be input into a machine learning model 112. As an example, when the training data 116 comprises text, the network device 104 may normalize the training data 116 based on keywords within the text. For example, the network device 104 may scan the text to determine whether any predefined keywords are present within the text. When one or more keywords are present within the text, the network device 104 may extract and use the identified keywords as the training data 116. In some instances, keywords from the text may be mapped to a set of standardized or common keywords. For instance, the network device 104 may be configured to map keywords from text such as “superior,” “satisfactory,” “acceptable,” “exemplary,” etc. with the keyword “good” from among the set of common keywords. In this case, the network device 104 may use the identified keywords from the set of common keywords as the training data 116. In other examples, the network device 104 may employ any other suitable natural language processing technique to normalize the text within the training data 116.

As another example, when the training data 116 comprises an image, the network device 104 may identify portions of the image to extract from the image to use as the training data 116. The portions of the image may correspond with objects or patterns that are present within the image. For instance, the network device 104 may identify a plurality of pixels within the image that corresponds with an object that is present within the image. The network device 104 may then extract and use the plurality of pixels to use as the training data 116. The network device 104 may use any suitable type of image processing technique to identify objects or patterns within the image.

As another example, the network device 104 may normalize the training data 116 by converting the training data 116 from a first data structure format into a second data structure format. For instance, the network device 104 may reformat the training data 116 by copying portions of the training data 116 from its original data structure into a template that has a different data structure. In other examples, the network device 104 may normalize the training data 116 using any other suitable technique. In some embodiments, the network device 104 may not normalize the training data 116, and step 206 may be optional or omitted.

At step 208, the network device 104 converts the training data 116 to a hexadecimal format (i.e. a base-16 numeric value). Here, the network device 104 encodes the training data 116 as a first set of hexadecimal values. The network device 104 may use any suitable technique for encoding the training data 116 as hexadecimal values. For example, when the training data 116 comprises text, the network device 104 may break down each byte (i.e. 8-bits) of text into two 4-bit values and then represent each 4-bit value using a hexadecimal value. As another example, when the training data 116 is an image, the network device 104 may break down each byte of the image into two 4-bit values and then represent each 4-bit value using a hexadecimal value. By encoding the training data 116 as hexadecimal values, the training data 116 can be used as a universal input into any type of machine learning model 112.

At step 210, the network device 104 trains the machine learning models 112 using the training data 116. During the training process, the machine learning model 112 determines weights and bias values that allow the machine learning model 112 to map certain types of training data 116 to different types of classification values 308 that identify the input data based on its features or characteristics. After training, each machine learning model 112 is configured to receive hexadecimal values as an input and to output a classification value 308 based on the input hexadecimal values. Through this process, each machine learning model 112 is trained to identify classification values 308 based on the input data. The network device 104 may be configured to train the machine learning models 112 using any suitable technique. In some embodiments, the machine learning models 112 may be trained by a third-party device (e.g. a cloud server) that is external from the network device 104.

At step 212, the network device 104 normalizes the test data 114. Since the test data 114 is the same data type as the training data 116, the network device 104 may normalize the test data 114 using a process similar to the process described in step 206. At step 214, the network device 104 converts the test data 114 to a hexadecimal format. The network device 104 may use any suitable technique for encoding the test data 114 as a second set of hexadecimal values. For example, the network device 104 may convert the test data 114 into a second set of hexadecimal values using a process similar to the process described in step 208.

At step 216, the network device 104 obtains classification values 308 from the machine learning models 112. The network device 104 begins this process by inputting the test data 114 into the machine learning model 112 as hexadecimal values. In response to inputting the test data 114 in the machine learning model 112, the network device 104 receives a classification value 308 from each of the machine learning models 112. In some embodiments, the network device 104 may convert the classification values 308 into a third set of hexadecimal values using a process similar to the process described in step 208. This process allows the network device 104 to provide an additional layer of information security by encoding or obfuscating the results from the machine learning models 112.

At step 218, the network device 104 determines performance metrics for the machine learning models 112. The performance metrics identify the performance of the network device 104 while executing each machine learning model 112 and/or the performance of each machine learning model 112. The network device 104 may measure central processing unit (CPU) utilization, graphics processing unit (GPU) utilization, memory utilization, processing time, latency time, or any other suitable type of metric for the network device 104 while executing each machine learning model 112 with the test data 114. The network device 104 may also determine a level of accuracy for each machine learning model 112 based on the classification value 308 that is determined by each machine learning model 112. The network device 104 may also measure the performance for each machine learning model 112 based on memory usage, the number of layers within each machine learning model 112, the weights and bias values used by each machine learning model 112, the number of features used, processing time, or any other suitable type of metric for a machine learning model 112. The network device 104 may also determine performance metrics based on a comparison between the performance of machine learning models 112. For example, the network device 104 may determine metrics for each machine learning model 112 compared to the other machine learning models 112.

At step 220, the network device 104 generates a model comparison report 120. The model comparison report 120 may comprise any combination of performance metrics for the network device 104 while executing each machine learning model 112 and/or performance metrics for the machine learning models 112. The network device 104 generates the model comparison report 120 using any suitable combination of text and/or graphical representations. In some embodiments, the network device 104 may flag or highlight the machine learning model 112 that yields the best performance. For example, the network device 104 may rank each machine learning model 112 based on its performance compared to the other machine learning models 112. In some embodiments, the model comparison report 120 may further comprise information about the layers, weights, biases, parameters, and/or settings of each of the machine learning models 112. This information can be used to recreate the machine learning models 112 on another device (e.g. the user device 102). For example, the model comparison report 120 may comprise instructions and information for recreating the machine learning model 112 that yielded the best performance. In some embodiments, the model comparison report 120 may comprise an executable file that can be used to implement a machine learning model 120. For example, the model comparison report 120 may comprise an executable file that can be used by another device to implement the machine learning model 112 that yielded the best performance.

At step 222, the network device 104 outputs the model comparison report 120. For example, the network device 104 may output the model comparison report 120 to the user device 102 by transmitting the model comparison report 120 as a message, an email, text, a file, a link, or in any other suitable format. For example, the network device 104 may transmit text that comprises the model comparison report 120 as a message an application notification or an email. The user device 102 may then display the model comparison report 120 to a user using a graphical user interface (e.g. a display). As another example, the network device 104 may transmit a file that includes model comparison report 120. In this example, a user may open the file using the user device 102 and then view the model comparison report 120 using a graphical user interface of the user device 102. When the model comparison report 120 comprises an executable file or instructions for recreating a machine learning model 112, the user may execute the executable file or implement the instructions to generate a machine learning model 112 on the user device 102. As another example, the network device 104 may generate and transmit a link to the model comparison report 120. In this example, a user may access the link on the user device 102 to view or download the model comparison report 120. In other examples, the network device 104 may output the model comparison report 120 to the user device 102 using any other suitable technique.

At step 224, the network device 104 determines whether to generate another set of machine learning models 112 for testing. For example, the network device 104 may query a user or a user device 102 to determine whether to generate another set of machine learning models 112. In one embodiment, a user may provide additional instructions to generate a new or different type of machine learning model 112. For example, the user may provide instructions that identify a different machine learning model type than the machine learning model type that was used to generate the previous set of machine learning models 112. In this example, the user may identify a different algorithm or machine learning model type than the one that was used to generate the previous set of machine learning models 112. In this case, the performance of the new set of machine learning models 112 may be compared to the performance of other types of machine learning models 112. This process allows a user to evaluate the performance of multiple instances of multiple types of machine learning models 112.

The network device 104 returns to step 202 in response to determining to generate another set of machine learning models 112 for testing. In this case, the network device 104 returns to step 202 to obtain the instructions for generating a new set of machine learning models 112 and to repeat steps 202-224 to test the performance of the new set of machine learning models 112. The network device 104 terminates process 200 in response to determining not to generate another set of machine learning models 112 for testing. In this case, the network device 104 concludes testing the set of machine learning models 112 and terminates process 200.

### Hardware Configuration for the Network Device

FIG. 3 is an embodiment of a network device 104 for the software testing system 100. As an example, the network device 104 may be a server or a computer. The network device 104 comprises a processor 302, a memory 110, and a network interface 304. The network device 104 may be configured as shown or in any other suitable configuration.

### Processor

The processor 302 comprises one or more processors operably coupled to the memory 110. The processor 302 is any electronic circuitry including, but not limited to, state machines, one or more CPU chips, logic units, cores (e.g. a multi-core processor), field-programmable gate array (FPGAs), application-specific integrated circuits (ASICs), or digital signal processors (DSPs). The processor 302 may be a programmable logic device, a microcontroller, a microprocessor, or any suitable combination of the preceding. The processor 302 is communicatively coupled to and in signal communication with the memory 110 and the network interface 304. The one or more processors are configured to process data and may be implemented in hardware or software. For example, the processor 302 may be 8-bit, 16-bit, 32-bit, 64-bit, or of any other suitable architecture. The processor 302 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute model testing instructions 306 to implement the model testing engine 108. In this way, processor 302 may be a special-purpose computer designed to implement the functions disclosed herein. In an embodiment, the model testing engine 108 is implemented using logic units, FPGAs, ASICs, DSPs, or any other suitable hardware. The model testing engine 108 is configured to operate as described in FIGS. 1-2. For example, the model testing engine 108 may be configured to perform the steps of process 200 as described in FIG. 2.

### Memory

The memory 110 is a hardware device that is operable to store any of the information described above with respect to FIGS. 1-2 along with any other data, instructions, logic, rules, or code operable to implement the function(s) described herein when executed by the processor 302. The memory 110 comprises one or more disks, tape drives, or solid-state drives, and may be used as an over-flow data storage device, to store programs when such programs are selected for execution, and to store instructions and data that are read during program execution. The memory 110 may be volatile or non-volatile and may comprise a read-only memory (ROM), random-access memory (RAM), ternary content-addressable memory (TCAM), dynamic random-access memory (DRAM), and static random-access memory (SRAM).

The memory 110 is operable to store model testing instructions 306, machine learning models 112, test data 114, training data 116, and/or any other data or instructions. The model testing instructions 306 may comprise any suitable set of instructions, logic, rules, or code operable to execute the model testing engine 108. The machine learning models 112, the test data 114, and the training data 116 are configured similar to the machine learning models 112, the test data 114, and the training data 116 described in FIGS. 1-2, respectively.

### Network Interface

The network interface 304 is a hardware device that is configured to enable wired and/or wireless communications. The network interface 304 is configured to communicate data between user devices 102 and other devices, systems, or domains. For example, the network interface 304 may comprise an NFC interface, a Bluetooth interface, a Zigbee interface, a Z-wave interface, a radio-frequency identification (RFID) interface, a WIFI interface, a LAN interface, a WAN interface, a PAN interface, a modem, a switch, or a router. The processor 302 is configured to send and receive data using the network interface 304. The network interface 304 may be configured to use any suitable type of communication protocol as would be appreciated by one of ordinary skill in the art.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A machine learning model testing device, comprising:
a memory operable to store:
training data having a first data type; and
test data having the first data type; and
a processor operably coupled to the memory, and configured to:
receive a user input that identifies:
a first machine learning model type; and
hyperparameters comprising:
a quantity value identifying a number of machine learning models for a set of machine learning models; and
settings for each machine learning model within the set of machine learning models;
generate the set of machine learning models based on the hyperparameters, wherein:
the number of machine learning models within the set of machine learning models is equal to the quantity value;
each machine learning model is the first machine learning model type; and
each machine learning model is uniquely configured based on the settings identified by the hyperparameters;
convert the training data into a first set of hexadecimal values, wherein each hexadecimal value is a base-16 numerical value;
train the set of machine learning models using the first set of hexadecimal values, wherein training the set of machine learning models configures each machine learning model to:
receive hexadecimal values as an input; and
output a classification value based on the input hexadecimal values;
convert the test data into a second set of hexadecimal values;
input the second set of hexadecimal values into each machine learning model within the set of machine learning models;
obtain a classification value from each machine learning model within the set of machine learning models, wherein the classification value identifies an input to a machine learning model;
determine performance metrics for each machine learning model based at least in part on a performance of the processor while each machine learning model while generates the classification value;
generate a model comparison report that comprises the performance metrics for each machine learning model; and
output the model comparison report.

2. The device of claim 1, wherein converting the training data into the first set of hexadecimal values comprises:
parsing the training data into a plurality of bytes; and
converting each byte into two hexadecimal values.

3. The device of claim 1, wherein:
the training data comprises text; and
converting the training data into the first set of hexadecimal values comprises:
identifying one or more keywords within the text; and
converting the one or more keywords into the first set of hexadecimal values.

4. The device of claim 1, wherein:
the training data comprises an image; and
converting the training data into the first set of hexadecimal values comprises:
identifying a plurality of pixels within the image that correspond with an object present in the image; and
converting the plurality of pixels to the first set of hexadecimal values.

5. The device of claim 1, wherein the processor is further configured to convert classification values from each machine learning model into a third set of hexadecimal values.

6. The device of claim 1, wherein:
the processor is further configured to determine a level of accuracy for each machine learning model within the set of machine learning models based on classification values from each machine learning model; and
the model comparison report comprises the level of accuracy.

7. The device of claim 1, wherein:
the processor is further configured to determine a processing time for each machine learning model within the set of machine learning models to determine the classification value; and
the model comparison report comprises the processing time.

8. A machine learning model testing method, comprising:
receiving a user input that identifies:
a first machine learning model type; and
hyperparameters comprising:
a quantity value identifying a number of machine learning models for a set of machine learning models; and
settings for each machine learning model within the set of machine learning models;
generating the set of machine learning models based on the hyperparameters, wherein:
the number of machine learning models within the set of machine learning models is equal to the quantity value;
each machine learning model is the first machine learning model type; and
each machine learning model is uniquely configured based on the settings identified by the hyperparameters;
converting training data into a first set of hexadecimal values, wherein each hexadecimal value is a base-16 numerical value;
training the set of machine learning models using the first set of hexadecimal values, wherein training the set of machine learning models configures each machine learning model to:
receive hexadecimal values as an input; and
output a classification value based on the input hexadecimal values;
converting test data into a second set of hexadecimal values;
inputting the second set of hexadecimal values into each machine learning model within the set of machine learning models;
obtaining a classification value from each machine learning model within the set of machine learning models, wherein the classification value identifies an input to a machine learning model;
determining performance metrics for each machine learning model based at least in part on a performance of the processor while each machine learning model while generates the classification value;
generating a model comparison report that comprises the performance metrics for each machine learning model; and
outputting the model comparison report.

9. The method of claim 8, wherein converting the training data into the first set of hexadecimal values comprises:
parsing the training data into a plurality of bytes; and
converting each byte into two hexadecimal values.

10. The method of claim 8, wherein:
the training data comprises text; and
converting the training data into the first set of hexadecimal values comprises:
identifying one or more keywords within the text; and
converting the one or more keywords into the first set of hexadecimal values.

11. The method of claim 8, wherein:
the training data comprises an image; and
converting the training data into the first set of hexadecimal values comprises:
identifying a plurality of pixels within the image that correspond with an object present in the image; and
converting the plurality of pixels to the first set of hexadecimal values.

12. The method of claim 8, further comprising converting classification values from each machine learning model into a third set of hexadecimal values.

13. The method of claim 8, further comprising determining a level of accuracy for each machine learning model within the set of machine learning models based on classification values from each machine learning model; and
wherein the model comparison report comprises the level of accuracy.

14. The method of claim 8, further comprising determining a processing time for each machine learning model within the set of machine learning models to determine the classification value; and
wherein the model comparison report comprises the processing time.

15. A computer program product comprising executable instructions stored in a non-transitory computer-readable medium that when executed by a processor causes the processor to:
receive a user input that identifies:
a first machine learning model type; and
hyperparameters comprising:
a quantity value identifying a number of machine learning models for a set of machine learning models; and
settings for each machine learning model within the set of machine learning models;
generate the set of machine learning models based on the hyperparameters, wherein:
the number of machine learning models within the set of machine learning models is equal to the quantity value;
each machine learning model is the first machine learning model type; and
each machine learning model is uniquely configured based on the settings identified by the hyperparameters;
convert training data into a first set of hexadecimal values, wherein each hexadecimal value is a base-16 numerical value;
train the set of machine learning models using the first set of hexadecimal values, wherein training the set of machine learning models configures each machine learning model to:
receive hexadecimal values as an input; and
output a classification value based on the input hexadecimal values;
convert test data into a second set of hexadecimal values;
input the second set of hexadecimal values into each machine learning model within the set of machine learning models;
obtain a classification value from each machine learning model within the set of machine learning models, wherein the classification value identifies an input to a machine learning model;
determine performance metrics for each machine learning model based at least in part on a performance of the processor while each machine learning model while generates the classification value;
generate a model comparison report that comprises the performance metrics for each machine learning model; and
output the model comparison report.

16. The computer program product of claim 15, wherein converting the training data into the first set of hexadecimal values comprises:
parsing the training data into a plurality of bytes; and
converting each byte into two hexadecimal values.

17. The computer program product of claim 15, wherein:
the training data comprises text; and
converting the training data into the first set of hexadecimal values comprises:
identifying one or more keywords within the text; and
converting the one or more keywords into the first set of hexadecimal values.

18. The computer program product of claim 15, wherein:
the training data comprises an image; and
converting the training data into the first set of hexadecimal values comprises:
identifying a plurality of pixels within the image that correspond with an object present in the image; and
converting the plurality of pixels to the first set of hexadecimal values.

19. The computer program product of claim 15, further comprising instructions that when executed by the processor configures to the processor to convert classification values from each machine learning model into a third set of hexadecimal values.

20. The computer program product of claim 15, further comprising instructions that when executed by the processor configures to the processor to determine a processing time for each machine learning model within the set of machine learning models to determine the classification value; and
wherein the model comparison report comprises the processing time.
